(19) United States
(12) Patent Application Publication
(10) Pub. No.: US 2023/0224806 A1
(43) Pub. Date: Jul. 13, 2023

(54) RECOVERY FROM AUTHENTICATION FAILURE

(71) Applicants: Hao ZHANG, San Diego, CA (US); Jian LI, San Diego, CA (US); Dongsheng WANG, San Diego, CA (US); Haibo LIU, San Diego, CA (US); ChaoFeng HUI, San Diego, CA (US); Fojian ZHANG, San Diego, CA (US); Yuankun ZHU, San Diego, CA (US); Tianya LIN, San Diego, CA (US); QUALCOMM Incorporated, San Diego, CA (US)

(72) Inventors: Hao ZHANG, Shanghai (CN); Jian LI, Shanghai (CN); Dongsheng WANG, Beijing (CN); Haibo LIU, Shanghai (CN); Chaofeng HUI, Beijing (CN); Fojian ZHANG, Shenzhen (CN); Yuankun ZHU, Shanghai (CN); Tianya LIN, Shanghai (CN)

(21) Appl. No.: 17/998,243

(22) PCT Filed: Jun. 19, 2020
(86) PCT No.: PCT/CN2020/097029

§ 371 Date: Nov. 8, 2022

(51) Int. Cl. H04W 48/18; H04W 60/04

(52) U.S. Cl. CPC H04W 48/18; H04W 60/04; H04W 84/042

(57) ABSTRACT

Techniques to recover from authentication failure are disclosed. During authentication of a user equipment (UE) with a public land mobile network (PLMN), the UE may receive an AUTHENTICATION REJECT with an extensible authentication protocol (EAP)-failure message. When this occurs, instead of invalidating the universal subscriber identity module (USIM) of the UE, the UE can search for other PLMNs that can potentially pass the authentication challenge. If one is found, the UE can register with the found PLMN.

### CROSS-REFERENCE TO RELATED APPLICATIONS

The present Application for Patent claims priority to International Patent Application No. PCT/CN2020/097029, entitled “RECOVERY FROM AUTHENTICATION FAILURE”, filed Jun. 19, 2020, which is assigned to the assignee hereof and is expressly incorporated herein by reference in its entirety.

### TECHNICAL FIELD

Various aspects described herein generally relate to wireless communication systems, and more particularly, to recovery from authentication failures such as recovery from extensible authentication protocol (EAP) failures in public land mobile network (PLMN) selection.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long-Term Evolution (LTE) or WiMax). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

5G New Radio (NR) connectivity, or simply NR connectivity, has gained significant commercial traction in recent time. Thus, to attract more users to their network, network operators would like to show NR connectivity to users most of the time on the user interface (UI) of the mobile device such as the user equipment (UE).

### SUMMARY

This summary identifies features of some example aspects, and is not an exclusive or exhaustive description of the disclosed subject matter. Whether features or aspects are included in, or omitted from this summary is not intended as indicative of relative importance of such features. Additional features and aspects are described, and will become apparent to persons skilled in the art upon reading the following detailed description and viewing the drawings that form a part thereof.

An exemplary user equipment (UE) is disclosed. The UE may comprise a processor, a memory, and a transceiver. The processor, the memory, and/or the transceiver may be configured to receive an authentication reject from an initial public land mobile network (PLMN). The processor, the memory, and/or the transceiver may also be configured to determine, subsequent to receiving the authentication reject from the initial PLMN, whether there other available PLMNs. The processor, the memory, and/or the transceiver may further be configured to select, when it is determined that there are other available PLMNs, a PLMN among the other available PLMNs. The processor, the memory, and/or the transceiver may yet be configured to register with the selected PLMN.

An exemplary method performed by a user equipment (UE) is disclosed. The method may comprise receiving an authentication reject from an initial public land mobile network (PLMN). The method may also comprise determining, subsequent to receiving the authentication reject from the initial PLMN, whether there other available PLMNs. The method may further comprise selecting, when it is determined that there are other available PLMNs, a PLMN among the other available PLMNs. The method may yet comprise registering with the selected PLMN.

Another exemplary user equipment (UE) is disclosed. The UE may comprise means for receiving an authentication reject from an initial public land mobile network (PLMN). The UE may also comprise means for determining, subsequent to receiving the authentication reject from the initial PLMN, whether there other available PLMNs. The UE may further comprise means for selecting, when it is determined that there are other available PLMNs, a PLMN among the other available PLMNs. The UE may yet comprise means for registering with the selected PLMN.

A non-transitory computer-readable medium storing computer-executable instructions for a user equipment (UE) is disclosed. The executable instructions may comprise one or more instructions instructing the UE to receive an authentication reject from an initial public land mobile network (PLMN). The executable instructions may also comprise one or more instructions instructing the UE to determine, subsequent to receiving the authentication reject from the initial PLMN, whether there other available PLMNs. The executable instructions may further comprise one or more instructions instructing the UE to select, when it is determined that there are other available PLMNs, a PLMN among the other available PLMNs. The executable instructions may yet comprise one or more instructions instructing the UE to register with the selected PLMN.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of examples of one or more aspects of the disclosed subject matter and are provided solely for illustration of the examples and not limitation thereof:

FIG. 1 illustrates an exemplary wireless communications system in accordance with one or more aspects of the disclosure;

FIG. 2 illustrates a simplified block diagram of several sample aspects of components that may be employed in wireless communication nodes and configured to support communication in accordance with one or more aspects of the disclosure;

FIG. 3 illustrates a flow of an example scenario that shows a technique implemented by a user equipment to recover from an authentication failure in accordance with one or more aspects of the disclosure;

FIGS. 4-6 illustrate flow charts of an exemplary method performed by a user equipment to recover from an authentication failure in accordance with one or more aspects of the disclosure;

FIG. 7 illustrates a simplified block diagram of several sample aspects of a user equipment apparatus configured for recovery from an authentication failure in accordance with one or more aspects of the disclosure.

### DETAILED DESCRIPTION

Aspects of the subject matter are provided in the following description and related drawings directed to specific examples of the disclosed subject matter. Alternates may be devised without departing from the scope of the disclosed subject matter. Additionally, well-known elements will not be described in detail or will be omitted so as not to obscure the relevant details.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein describes particular aspects only and should not be construed to limit any aspects disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “user equipment” (UE) and “base station” are not intended to be specific or otherwise limited to any particular Radio Access Technology (RAT), unless otherwise noted. In general, such UEs may be any wireless communication device (e.g., a mobile phone, router, tablet computer, laptop computer, tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an Access Point (AP), a Network Node, a NodeB, an evolved NodeB (eNB), a general Node B (gNodeB, gNB), etc. In addition, in some systems a base station may provide edge node signaling functions while in other systems it may provide additional control and/or network management functions.

UEs can be embodied by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

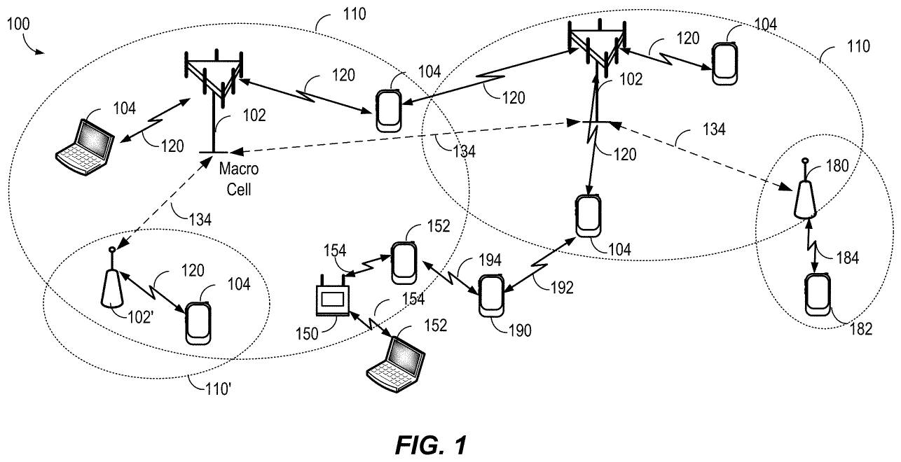

FIG. 1 illustrates an exemplary wireless communications system 100 according to one or more aspects. The wireless communications system 100, which may also be referred to as a wireless wide area network (WWAN), may include various base stations 102 and various UEs 104. The base stations 102 may include macro cells (high power cellular base stations) and/or small cells (low power cellular base stations). The macro cells may include Evolved NodeBs (eNBs) where the wireless communications system 100 corresponds to an Long-Term Evolution (LTE) network, gNodeBs (gNBs) where the wireless communications system 100 corresponds to a 5G network, and/or a combination thereof, and the small cells may include femtocells, picocells, microcells, etc.

The base stations 102 may collectively form a Radio Access Network (RAN) and interface with an Evolved Packet Core (EPC) or Next Generation Core (NGC) through backhaul links. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, although not shown in FIG. 1, coverage areas 110 may be subdivided into a plurality of cells (e.g., three), or sectors, each cell corresponding to a single antenna or array of antennas of a base station 102. As used herein, the term “cell” or “sector” may correspond to one of a plurality of cells of a base station 102, or to the base station 102 itself, depending on the context.

While neighbor macro cell geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cells may be known as a heterogeneous network. A heterogeneous network may also include Home eNBs (HeNBs) and/or Home gNodeBs, which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple input multiple output (MIMO) antenna technology, including spatial multiplexing, beamforming, and/or transmit diversity. The communication links may be through one or more carriers. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a mmW base station 180 that may operate in mmW frequencies and/or near mmW frequencies in communication with a UE 182. Extremely high frequency (EHF) is part of the radio frequency (RF) range in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 may utilize beamforming 184 with the UE 182 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

The wireless communications system 100 may further include one or more UEs, such as UE 190, that connects indirectly to one or more communication networks via one or more device-to-device (D2D) peer-to-peer (P2P) links. In the embodiment of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192-194 may be supported with any well-known D2D radio access technology (RAT), such as LTE Direct (LTE-D), WiFi Direct (WiFi-D), Bluetooth, and so on. Any of the base stations 102, 102′, 180 may send measurement requests (e.g., measurement control order (MCO)) to the UEs 104, 182, 190, and the UE's 104, 182, 190 may respond with measurement reports accordingly.

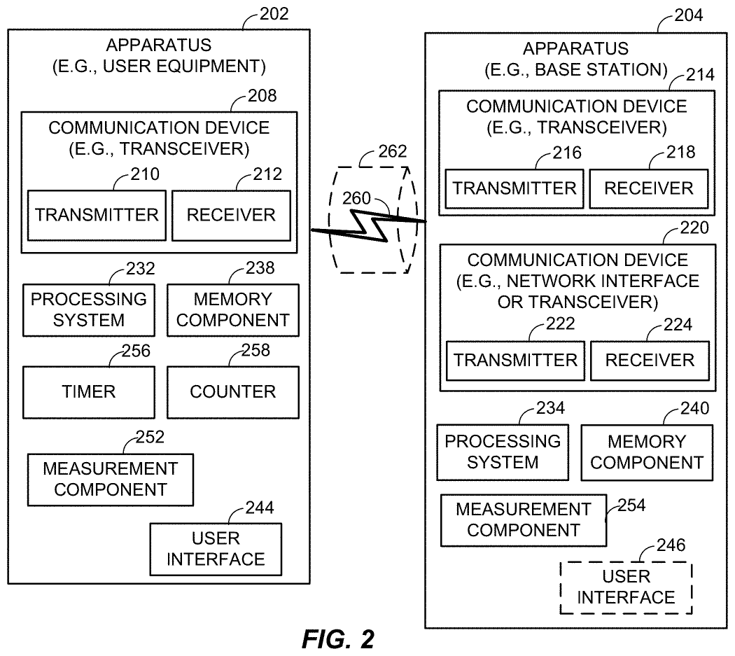

FIG. 2 illustrates several sample components (represented by corresponding blocks) that may be incorporated into an apparatus 202 and an apparatus 204 (corresponding to, for example, a UE and a base station (e.g., eNB, gNB), respectively, to support the operations as disclosed herein. As an example, the apparatus 202 may correspond to a UE, and the apparatus 204 may correspond to a network node such as a gNB and/or an eNB. It will be appreciated that the components may be implemented in different types of apparatuses in different implementations (e.g., in an ASIC, in a System-on-Chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The apparatus 202 and the apparatus 204 each may include at least one wireless communication device (represented by the communication devices 208 and 214) for communicating with other nodes via at least one designated RAT (e.g., LTE, New Radio (NR)). Each communication device 208 may include at least one transmitter (represented by the transmitter 210) for transmitting and encoding signals (e.g., messages, indications, information, and so on) and at least one receiver (represented by the receiver 212) for receiving and decoding signals (e.g., messages, indications, information, pilots, and so on). Each communication device 214 may include at least one transmitter (represented by the transmitter 216) for transmitting signals (e.g., messages, indications, information, pilots, and so on) and at least one receiver (represented by the receiver 218) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include a plurality of antennas, such as an antenna array, that permits the respective apparatus to perform transmit “beamforming,” as described further herein. Similarly, a receiver may include a plurality of antennas, such as an antenna array, that permits the respective apparatus to perform receive beamforming, as described further herein. In an aspect, the transmitter and receiver may share the same plurality of antennas, such that the respective apparatus can only receive or transmit at a given time, not both at the same time. A wireless communication device (e.g., one of multiple wireless communication devices) of the apparatus 204 may also comprise a Network Listen Module (NLM) or the like for performing various measurements.

The apparatus 204 may include at least one communication device (represented by the communication device 220) for communicating with other nodes. For example, the communication device 220 may comprise a network interface (e.g., one or more network access ports) configured to communicate with one or more network entities via a wire-based or wireless backhaul connection. In some aspects, the communication device 220 may be implemented as a transceiver configured to support wire-based or wireless signal communication. This communication may involve, for example, sending and receiving messages, parameters, or other types of information. Accordingly, in the example of FIG. 2, the communication device 220 is shown as comprising a transmitter 222 and a receiver 224 (e.g., network access ports for transmitting and receiving).

The apparatuses 202 and 204 may also include other components used in conjunction with the operations as disclosed herein. The apparatus 202 may include a processing system 232 for providing functionality relating to, for example, communication with the network. The apparatus 204 may include a processing system 234 for providing functionality relating to, for example, communication with the UEs. In an aspect, the processing systems 232 and 234 may include, for example, one or more general purpose processors, multi-core processors, ASICs, digital signal processors (DSPs), field programmable gate arrays (FPGA), or other programmable logic devices or processing circuitry.

The apparatuses 202 and 204 may include measurement components 252 and 254 that may be used to obtain channel related measurements. The measurement component 252 may measure one or more downlink (DL) signals such as channel state information reference signal (CSI-RS), phase tracking reference signal (PTRS), primary synchronization signal (PSS), secondary synchronization signal (SSS), demodulation reference signal (DMRS), etc. The measurement component 254 may measure one or more uplink (UL) signals such as DMRS, sounding reference signal (SRS), etc.

The apparatuses 202 and 204 may include memory components 238 and 240 (e.g., each including a memory device), respectively, for maintaining information (e.g., information indicative of reserved resources, thresholds, parameters, and so on). In various implementations, memory 238 can comprise a computer-readable medium storing one or more computer-executable instructions for a user equipment (UE) where the one or more instructions instruct apparatus 202 (e.g., processing system 232 in combination with communications device 208 and/or other aspects of apparatus 202) to perform any of the functions disclosed herein. In addition, the apparatuses 202 and 204 may include user interface devices 244 and 246, respectively, for providing indications (e.g., audible and/or visual indications) to a user and/or for receiving user input (e.g., upon user actuation of a sensing device such a keypad, a touch screen, a microphone, and so on).

The apparatus 202 may include a timer 256 and a counter 258. The timer 256 may be configured to measure or otherwise determine one or more time durations. The counter 258 may be configured to count or otherwise determine occurrences of one or more events.

For convenience, the apparatuses 202 and 204 are shown in FIG. 2 as including various components that may be configured according to the various examples described herein. It will be appreciated, however, that the illustrated blocks may have different functionality in different designs. The components of FIG. 2 may be implemented in various ways. In some implementations, the components of FIG. 2 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 208, 232, 238, and 244 may be implemented by processor and memory component(s) of the apparatus 202 (e.g., by execution of appropriate code and/or by appropriate configuration of processor components). Similarly, some or all of the functionality represented by blocks 214, 220, 234, 240, and 246 may be implemented by processor and memory component(s) of the apparatus 204 (e.g., by execution of appropriate code and/or by appropriate configuration of processor components).

In an aspect, the apparatus 204 may correspond to a “small cell” or a Home gNodeB. The apparatus 202 may transmit and receive messages via a wireless link 260 with the apparatus 204, the messages including information related to various types of communication (e.g., voice, data, multimedia services, associated control signaling, etc.). The wireless link 260 may operate over a communication medium of interest, shown by way of example in FIG. 2 as the medium 262, which may be shared with other communications as well as other RATs. A medium of this type may be composed of one or more frequency, time, and/or space communication resources (e.g., encompassing one or more channels across one or more carriers) associated with communication between one or more transmitter/receiver pairs, such as the apparatus 204 and the apparatus 202 for the medium 262.

In general, the apparatus 202 and the apparatus 204 may operate via the wireless link 260 according to one or more radio access types, such as LTE, LTE-U, or NR, depending on the network in which they are deployed. These networks may include, for example, different variants of CDMA networks (e.g., LTE networks, NR networks, etc.), TDMA networks, FDMA networks, Orthogonal FDMA (OFDMA) networks, Single-Carrier FDMA (SC-FDMA) networks, and so on.

A UE may be capable of operating in multiple radio access technologies (RATs). For example, a UE may be capable of operating in a first RAT (e.g., LTE) and in a second RAT (e.g., NR). These are merely examples, and first and second RATs may be any of the RATs currently known (e.g., WiMax, CDMA, WCDMA, UTRA, Evolved Universal Terrestrial Radio Access (E-UTRA), GSM, FDMA, GSM, TDMA, etc.).

Also, a UE may be may be capable of operating in multiple RATs at the same time. For example, a UE that can operate in both LTE and NR simultaneously is an E-UTRA-NR Dual Connectivity (ENDC) capable UE. Note that ENDC is an example of Multi-RAT DC (MRDC) capability. In general, when an MRDC capable UE is operating in two RATs, it may be communicating with a base station (e.g., eNB) of a first RAT (e.g., LTE) and with a base station (e.g., gNB) of a second RAT (e.g., NR). When the UE operates in the first RAT, it may communicate with a network node (e.g., base station, eNB, etc.) of the first RAT. Similarly, when the UE operates in the second RAT, it may communicate with a network node (e.g., base station, gNB, etc.) of the second RAT.

The UE may be capable of operating in a standalone (SA) or in a non-standalone (NSA) mode within a given RAT. When operating in the SA mode, the UE is able to exchange both control and data plane (also referred to as user plane) information with the network node and/or the core network of the given RAT (e.g., NR). When operating in the NSA mode, the UE is communicating with network nodes of the first and second RATs. In the NSA mode, the UE can exchange data plane information with the network nodes of both the first RAT (e.g., LTE) and the second RAT (e.g., NR). However, the control plane information is exchanged only with the network node of the first RAT (e.g., LTE).

At switch on, or following recovery from lack of coverage such as loss of service, a UE selects a public land mobile network (PLMN) and connects to the selected PLMN, which begins a process to authenticate the UE. For mutual authentication between the UE and a network in 5G NR, an extensible authentication protocol (EAP) authentication and key agreement (AKA)—EAP-AKA′—procedure can be used. During authentication, the UE receives an AUTHENTICATION REQUEST from the PLMN. In response, the UE sends an AUTHENTICATION RESPONSE. If the UE is not authenticated, the UE receives an EAP-failure message within an AUTHENTICATION REJECT from the PLMN.

Release 16 of 3GPP (Third Generation Partnership Project) TS 24.501 (herein incorporated by reference in its entirety), section 5.4.1.2.2.11 specifies the UE's handling of the EAP-failure message. It states “If the EAP-failure message is received in an AUTHENTICATION REJECT message . . . the USIM shall be considered invalid until switching off the UE or the UICC containing the USIM is removed.” This means that when the UE receives the AUTHENTICATION REJECT with the EAP-failure, the UE will not be able to provide connection services to its user.

When the UE is roaming, i.e., when no cells of the UE's HPLMN or EHPLMN are available, the UE will attempt to connect to available visiting PLMNs. When there are multiple visiting PLMNs available, the UE can randomly select one of the available PLMNs, connect to the selected PLMN, and authenticate itself with the selected PLMN. If the authentication fails with EAP-failure, then the UE will not be able to provide services. This can occur even when there may be other PLMNs with whom the UE can pass the authentication challenge.

For illustration purposes, assume that the UE is roaming, and that there are two PLMNs available. Also assume that if the UE would fail if it tries to authenticate with the first PLMN but would succeed if it tries to authenticate with the second PLMN. For example, the first PLMN may have no agreements in place with the UE's HPLMN/EHPLMN to allow the UE to utilize services of the first PLMN, while the second PLMN does. In another example, the first PLMN may be unable to communicate with the HPLMN/EHPLMN, e.g., due to a disruption in their connection. This can prevent the first PLMN from retrieving UE's authentication information from the HPLMN/EHPLMN. On the other hand, the second PLMN may be able to communicate with the HPLMN/EHPLMN

At switch on, the UE randomly selects between the first and second PLMNs. Unfortunately, if the UE selects the first PLMN and attempts to authenticate, its attempt will fail, and the UE will no longer be able to provide service since the UE's USIM is invalidated. This is despite the fact that the second PLMN is available.

To address such issues, it is proposed that the UE trigger a PLMN search to check whether if any other PLMN is available in case of authentication failure with the selected PLMN. If another PLMN is found, the UE then may attempt to register with that PLMN. Also, to avoid future attempts to register with the failed PLMN, the UE may store the PLMN and/or tracking area code (TAC) into a forbidden list.

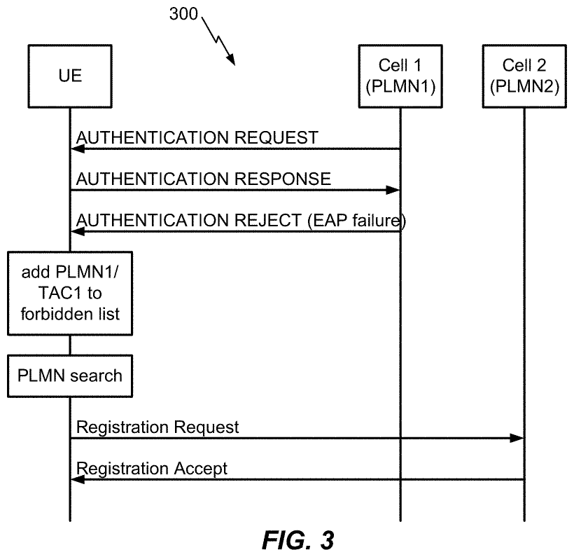

FIG. 3 illustrates an example of a scenario 300 in which a UE recovers from an authentication failure. Regarding FIG. 3, the following may be assumed:
Cell 1 belongs to PLMN1, cell 2 belongs to PLMN2;
PLMN1 and PLMN2 are different PLMNs;
Neither PLMN1 nor PLMN2 is the HPLMN/EHPLMN of the UE;
UE is operating in standalone (SA) mode.

The sequence in scenario 300 may be as follows:
A. Authentication with PLMN1 fails:
   PLMN1 sends AUTHENTICATION REQUEST to UE;
   UE sends AUTHENTICATION RESPONSE to PLMN1;
   PLMN1 sends AUTHENTICATION REJECT with EAP failure.
B. Prevent future registration attempts with failed PLMN/TAC:
   UE adds PLMN and/or TAC to forbidden list;
C. Search for other possible PLMNs when authentication fails:
   UE trigger/conduct PLMN search;
D. Register with found candidate PLMN:
   UE sends Registration Request to PLMN2;
   PLMN2 responds with Registration Accept to UE.

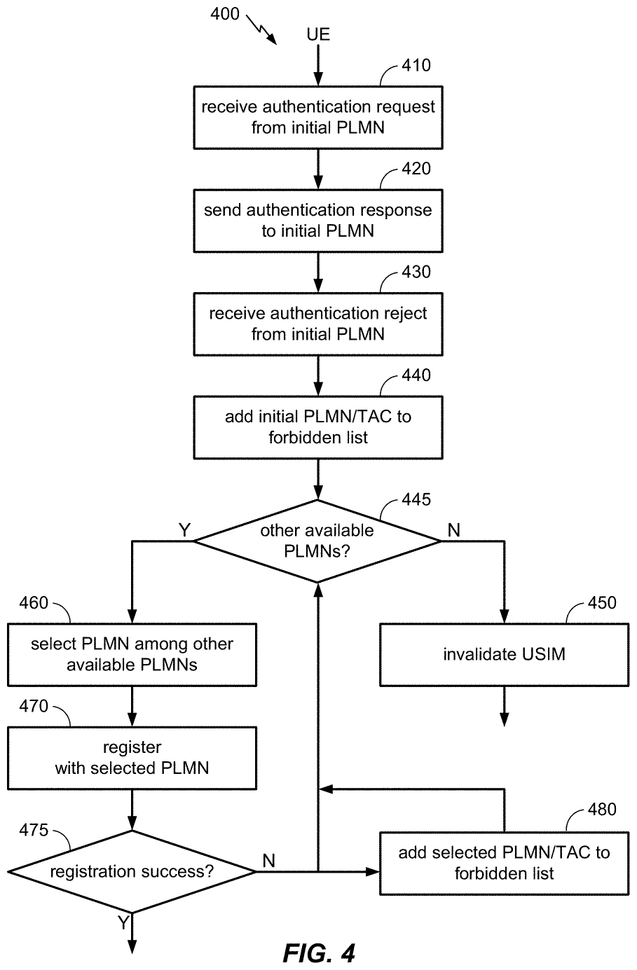

FIG. 4 illustrates a flow chart of an exemplary method 400 performed by a UE to recover from authentication failure in accordance with one or more aspects of the disclosure. FIG. 4 may be viewed as a generalization of the flow of FIG. 3. Here, the UE (such as the UE 202) may be capable of operating in one or more radio access technologies (RATs) such as 5G NR and 4G LTE. The memory component 238 may be viewed as an example of a non-transitory computer-readable medium that stores computer-executable instructions to operate components of the UE 202 such as the transceiver 208 (including transmitter 210 and receiver 212), the processing system 232 (including one or more processors), memory component 238, etc. In the method 400, the UE may be in a standalone (SA) mode.

In block 410, the UE may receive an authentication request from a PLMN. For ease of reference, this PLMN may be referred to as an initial PLMN. The initial PLMN may be a visited PLMN. That is, the initial PLMN may be neither an HPLMN nor an EHPLMN of the UE. In an aspect, the initial PLMN may correspond to PLMN1 in FIG. 3. Means for performing block 410 may include the processing system 232, the memory component 238 and/or the transceiver 208 of the UE 202.

In block 420, the UE may send an authentication response to the initial PLMN as a response to the authentication request. Means for performing block 420 may include the processing system 232, the memory component 238 and/or the transceiver 208 of the UE 202.

In block 430, the UE may receive an authentication reject from the initial PLMN. In an aspect, the authentication reject may include an extensible authentication protocol (EAP)-fail message. Means for performing block 430 may include the processing system 232, the memory component 238 and/or the transceiver 208 of the UE 202.

As a result of receiving the authentication reject, the UE in block 440 may add the initial

PLMN and/or one or more tracking area codes (TACs) of the initial PLMN into a forbidden list stored within the UE (e.g., in memory component 238). When not empty, one or more PLMNs and/or one or more TACs of the one or more PLMNs may be included in the forbidden list. The UE will not attempt to connect with the PLMNs and/or the TACs of the forbidden list. Means for performing block 440 may include the processing system 232 and/or the memory component 238 of the UE 202.

Since authentication with the initial PLMN failed, the UE in block 445 may determine whether there are other available PLMNs. For example, the UE may search for signals from cells of other PLMNs that the UE may potentially pass the authentication challenge. In an aspect, these other available PLMNs may also be visited PLMNs, i.e., not HPLMNs and not EHPLMNs. Means for performing block 445 may include the processing system 232, the memory component 238 and/or the transceiver 208 of the UE 202.

When it is determined that there are no other available PLMNs (N branch from block 445), then the UE in block 450 may invalidate the USIM of the UE. Means for performing block 450 may include the processing system 232 and/or the memory component 238 of the UE 202.

On the other hand, when it is determined that there are other available PLMNs (Y branch from block 445), then the UE in block 460 may select a PLMN among the other available PLMNs. For example, the UE may search for signals from cells of the other available PLMNs. Means for performing block 460 may include the processing system 232, the memory component 238 and/or the transceiver 208 of the UE 202.

In block 470, the UE may register with the selected PLMN. Means for performing block 470 may include the processing system 232, the memory component 238 and/or the transceiver 208 of the UE 202.

In block 475, the UE may determine whether registering with the selected PLMN is successful. Means for performing block 475 may include the processing system 232, the memory component 238 and/or the transceiver 208 of the UE 202.

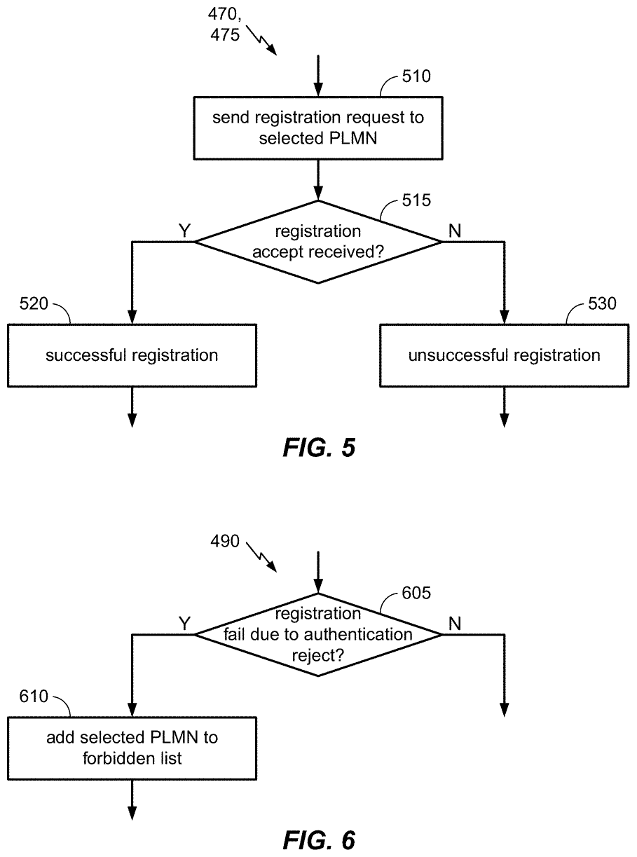

FIG. 5 illustrates a flow chart of an example process performed by the UE to implement blocks 470 and 475. In block 510, the UE may send a registration request to the selected PLMN. Means for performing block 510 may include the processing system 232, the memory component 238 and/or the transceiver 208 of the UE 202.

In block 515, the UE may determine whether a registration accept is received from the selected PLMN in response to the registration request. Means for performing block 515 may include the processing system 232, the memory component 238 and/or the transceiver 208 of the UE 202.

When the registration accept is received (Y branch from block 515), then the UE in block 520 may determine that registering with the selected PLMN is successful. On the other hand, when the registration accept is not received (N branch from block 515), then the UE in block 530 may determine that registering with the selected PLMN is unsuccessful. Each of the means for performing block 520 and the means for performing block 530 may include the processing system 232 and/or the memory component 238 of the UE 202.

Referring back to FIG. 4, when the registration is determined to be successful (Y branch from block 475), the UE may then proceed to receive services from the selected PLMN. When the registration is not determined to be successful (N branch from block 475), the UE may proceed to block 445 and repeat the search for available PLMNs.

In addition, when the registration is not determined to be successful (N branch from block 475), the UE in block 480 may add the selected PLMN and/or one or more TACs of the selected PLMN to the forbidden list. Means for performing block 480 may include the processing system 232 and/or the memory component 238 of the UE 202.

In one aspect, the UE in block 480 may simply add the selected PLMN and/or the TACs of the selected PLMN to the forbidden list. Alternatively, the UE in block 480 may be selective about adding to the forbidden list. FIG. 6 illustrates a flow chart of an example process performed by the UE to implement the alternative block 480.

In block 605, the UE may determine whether the registering with the selected PLMN failed due to receiving an authentication reject. In particular, the UE may determine that registering with the PLMN failed when the authentication reject includes the EAP-fail message. Means for performing block 605 may include the processing system 232, the memory component 238 and/or the transceiver 208 of the UE 202.

If it is determined that the registering with selected failed due to receiving the authentication reject (e.g., with the EAP-failure message) (Y branch from block 605), then the UE in block 610 may add the selected PLMN and/or the TACs of the selected PLMN to the forbidden list.

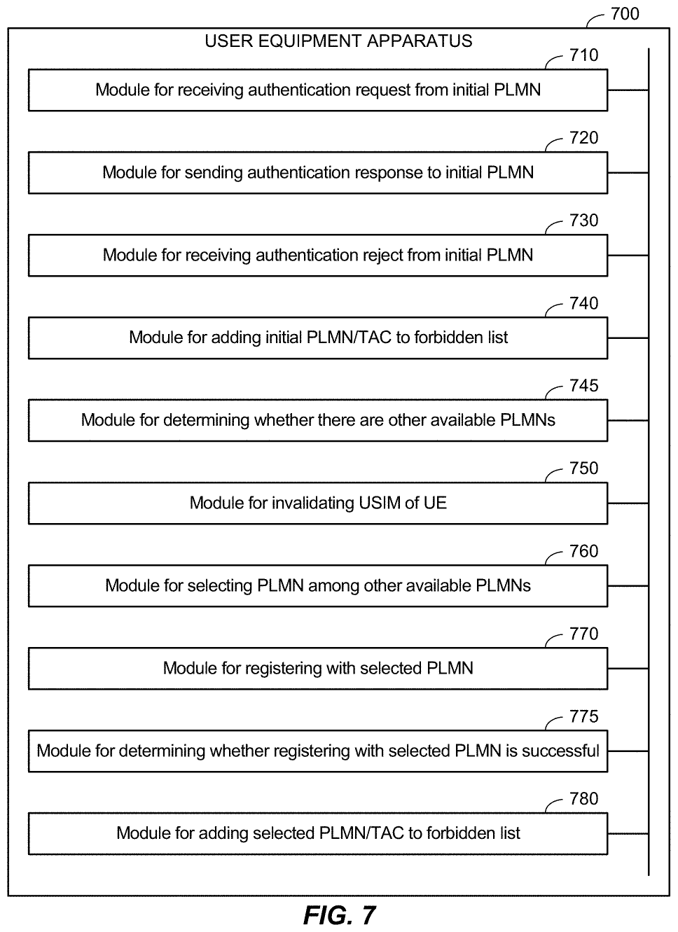

FIG. 7 illustrates an example user equipment apparatus 700 represented as a series of interrelated functional modules connected by a common bus. Each of the modules may be implemented in hardware or as a combination of hardware and software. For example, the modules may be implemented as any combination of the modules of the apparatus 202 of FIG. 2. A module for receiving the authentication request from the initial PLMN 710 may correspond at least in some aspects to a communication device (e.g., communication device 208), a processing system (e.g., processing system 232) and/or a memory component (e.g., memory component 238). A module for sending the authentication response to the initial PLMN 720 may correspond at least in some aspects to a communication device (e.g., communication device 208), a processing system (e.g., processing system 232) and/or a memory component (e.g., memory component 238). A module for receiving the authentication reject from the initial PLMN 730 may correspond at least in some aspects to a communication device (e.g., communication device 208), a processing system (e.g., processing system 232) and/or a memory component (e.g., memory component 238). A module for adding the initial PLMN and/or TACs of the initial PLMN 740 may correspond at least in some aspects to a processing system (e.g., processing system 232) and/or a memory component (e.g., memory component 238). A module for determining whether there are other available PLMNs 745 may correspond at least in some aspects to a communication device (e.g., communication device 208), a processing system (e.g., processing system 232) and/or a memory component (e.g., memory component 238). A module for invalidating the USIM of the UE 750 may correspond at least in some aspects to a processing system (e.g., processing system 232) and/or a memory component (e.g., memory component 238). A module for selecting the PLMN among the other available PLMNs 760 may correspond at least in some aspects to a communication device (e.g., communication device 208), a processing system (e.g., processing system 232) and/or a memory component (e.g., memory component 238). A module for registering with the selected PLMN 770 may correspond at least in some aspects to a communication device (e.g., communication device 208), a processing system (e.g., processing system 232) and/or a memory component (e.g., memory component 238). A module for determining whether registering with the selected PLMN is successful 775 may correspond at least in some aspects to a communication device (e.g., communication device 208), a processing system (e.g., processing system 232) and/or a memory component (e.g., memory component 238). A module for adding the selected PLMN and/or TACs of the selected PLMN 740 may correspond at least in some aspects to a processing system (e.g., processing system 232) and/or a memory component (e.g., memory component 238).

The functionality of the modules of FIG. 7 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 7, as well as other components and functions described herein, may be implemented using any suitable means. Such means also may be implemented, at least in part, using corresponding structure as taught herein. For example, the components described above in conjunction with the “module for” components of FIG. 7 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A user equipment (UE), comprising:
a processor;
a memory; and
a transceiver,
wherein the processor, the memory, and/or the transceiver are configured to:
receive an authentication reject from an initial public land mobile network (PLMN);
determine, subsequent to receiving the authentication reject from the initial PLMN, whether there are other available PLMNs;
select, when it is determined that there are other available PLMNs, a PLMN among the other available PLMNs; and
register with the selected PLMN.

2. The UE of claim 1, wherein the initial PLMN and the other available PLMNs are 5G New Radio (NR) PLMNs.

3. The UE of claim 1, wherein the UE is in a standalone (SA) mode.

4. The UE of claim 1,
wherein none of the initial PLMN and the other available PLMNs are home PLMNs of the UE, and
wherein none of the initial PLMN and the other available PLMNs are equivalent home PLMNs of the UE.

5. The UE of claim 1, wherein the authentication reject from the initial PLMN includes an extensible authentication protocol (EAP)-fail message.

6. The UE of claim 1, wherein the processor, the memory, and/or the transceiver are further configured to:
receive an authentication request from the initial PLMN; and
send, subsequent to receiving the authentication request, an authentication response to the initial PLMN,
wherein the authentication response is sent prior to the authentication reject being received.

7. The UE of claim 1,
wherein a forbidden list is stored within the UE, the forbidden list comprising one or more PLMNs and/or tracking area codes (TAC) of the one or more PLMNs that the UE will not attempt to connect with, and
wherein the processor, the memory, and/or the transceiver are further configured to:
add, subsequent to receiving the authentication reject from the initial PLMN, the initial PLMN and/or one or more TACs of the initial PLMN to the forbidden list.

8. The UE of claim 1, wherein the processor, the memory, and/or the transceiver are further configured to:
invalidate, when it is determined that there are no other available PLMNs, a universal subscriber identity module (USIM) of the UE.

9. The UE of claim 1, wherein the processor, the memory, and/or the transceiver are further configured to:
determine whether registering with the selected PLMN is successful; and
repeat, when it is determined that registering with the selected PLMN is unsuccessful, determining whether there are other available PLMNs.

10. The UE of claim 9, wherein in registering with the selected PLMN and determining whether registering is successful, the processor, the memory, and/or the transceiver are configured to:
send a registration request to the selected PLMN;
determine whether a registration accept is received from the selected PLMN in response to the registration request;
determine that registering with the selected PLMN is successful when the registration accept is received; and
determine that registering with the selected PLMN is unsuccessful when the registration accept is not received.

11. The UE of claim 9,
wherein a forbidden list is stored within the UE, the forbidden list comprising one or more PLMNs and/or tracking area codes (TAC) of the one or more PLMNs that the UE will not attempt to connect with, and
wherein the processor, the memory, and/or the transceiver are further configured to:
add, when it is determined that registering with the selected PLMN is unsuccessful, the selected PLMN and/or one or more TACs of the selected PLMN to the forbidden list.

12. The UE of claim 11, wherein in adding the selected PLMN and/or one or more TACs of the selected PLMN to the forbidden list, the processor, the memory, and/or the transceiver are further configured to:
determine whether registering with the selected PLMN is unsuccessful due to receiving the authentication reject from the selected PLMN; and
add, when it is determined that registering with the selected PLMN is unsuccessful due to receiving the authentication reject from the selected PLMN, the selected PLMN and/or the one or more TACs of the selected PLMN to the forbidden list.

13. The UE of claim 12, wherein it is determined that the registering with the selected PLMN is unsuccessful when the authentication reject from the selected PLMN includes an extensible authentication protocol (EAP)-fail message.

14. A method of a user equipment (UE), comprising:
receiving an authentication reject from an initial public land mobile network (PLMN);
determining, subsequent to receiving the authentication reject from the initial PLMN, whether there are other available PLMNs;
selecting, when it is determined that there are other available PLMNs, a PLMN among the other available PLMNs; and
registering with the selected PLMN.

15. The method of claim 14, wherein the initial PLMN and the other available PLMNs are 5G New Radio (NR) PLMNs.

16. The method of claim 14, wherein the UE is in a standalone (SA) mode.

17. The method of claim 14,
wherein none of the initial PLMN and the other available PLMNs are home PLMNs of the UE, and
wherein none of the initial PLMN and the other available PLMNs are equivalent home PLMNs of the UE.

18. The method of claim 14, wherein the authentication reject from the initial PLMN includes an extensible authentication protocol (EAP)-fail message.

19. The method of claim 14, further comprising:
receiving an authentication request from the initial PLMN; and
sending, subsequent to receiving the authentication request, an authentication response to the initial PLMN,
wherein the authentication response is sent prior to the authentication reject being received.

20. The method of claim 14,
wherein a forbidden list is stored within the UE, the forbidden list comprising one or more PLMNs and/or tracking area codes (TAC) of the one or more PLMNs that the UE will not attempt to connect with, and
wherein the method further comprises:
adding, subsequent to receiving the authentication reject from the initial PLMN, the initial PLMN and/or one or more TACs of the initial PLMN to the forbidden list.

21. The method of claim 14, further comprising:
invalidating, when it is determined that there are no other available PLMNs, a universal subscriber identity module (USIM) of the UE.

22. The method of claim 14, further comprising:
determining whether registering with the selected PLMN is successful; and
repeating, when it is determined that registering with the selected PLMN is unsuccessful, determining whether there are other available PLMNs.

23. The method of claim 22, wherein registering with the selected PLMN and determining whether registering is successful comprise:
sending a registration request to the selected PLMN;
determining whether a registration accept is received from the selected PLMN in response to the registration request;
determining that registering with the selected PLMN is successful when the registration accept is received; and
determining that registering with the selected PLMN is unsuccessful when the registration accept is not received.

24. The method of claim 22,
wherein a forbidden list is stored within the UE, the forbidden list comprising one or more PLMNs and/or tracking area codes (TAC) of the one or more PLMNs that the UE will not attempt to connect with, and
wherein the method further comprises:
adding, when it is determined that registering with the selected PLMN is unsuccessful, the selected PLMN and/or one or more TACs of the selected PLMN to the forbidden list.

25. The method of claim 24, wherein adding the selected PLMN and/or one or more TACs of the selected PLMN to the forbidden list comprises:
determining whether registering with the selected PLMN is unsuccessful due to receiving the authentication reject from the selected PLMN; and
adding, when it is determined that registering with the selected PLMN is unsuccessful due to receiving the authentication reject from the selected PLMN, the selected PLMN and/or the one or more TACs of the selected PLMN to the forbidden list.

26. The method of claim 25, wherein it is determined that the registering with the selected PLMN is unsuccessful when the authentication reject from the selected PLMN includes an extensible authentication protocol (EAP)-fail message.

27. A user equipment (UE), comprising:
means for receiving an authentication reject from an initial public land mobile network (PLMN);
means for determining, subsequent to receiving the authentication reject from the initial PLMN, whether there are other available PLMNs;
means for selecting, when it is determined that there are other available PLMNs, a PLMN among the other available PLMNs; and
means for registering with the selected PLMN.

28. A non-transitory computer-readable medium storing computer-executable instructions for a user equipment (UE), the computer-executable instructions comprising:
one or more instructions instructing the UE to receive an authentication reject from an initial public land mobile network (PLMN);
one or more instructions instructing the UE to determine, subsequent to receiving the authentication reject from the initial PLMN, whether there are other available PLMNs;
one or more instructions instructing the UE to select, when it is determined that there are other available PLMNs, a PLMN among the other available PLMNs; and
one or more instructions instructing the UE to register with the selected PLMN.
